(19) United States
(12) Patent Application Publication
(10) Pub. No.: US 2010/0237580 A1
(43) Pub. Date: Sep. 23, 2010

(54) WHEEL GUIDE CONTROL ARM FOR AN ACTIVE CHASSIS

(75) Inventors: Jens Vortmeyer, Preussisch-Oldendorf (DE); Hubert Siemer, Dinklage (DE); Michael Fangmann, Lohne (DE); Nicole Knüppel, Lembruch (DE)

Correspondence Address: MCGLEW & TUTTLE, PC, P.O. BOX 9227, SCARBOROUGH STATION, SCARBOROUGH, NY, 10510-9227, US

(73) Assignee: ZF FRIEDRICHSHAFEN AG, Friedrichshafen (DE)

(21) Appl. No.: 12/294,978

(22) PCT Filed: Mar. 2, 2007
(86) PCT No.: PCT/DE2007/000398

§ 371 Date: Sep. 29, 2008

(30) Foreign Application Priority Data
Mar. 30, 2006 (DE) 10 2006 015 169.0

(51) Int. Cl. B60G 7/00; F16C 25/00

(52) U.S. Cl. 280/124.134; 384/261

(57) ABSTRACT

A wheel guide control arm (1) is provided for an axle of a motor vehicle. The wheel guide control arm (1) has two end areas (2, 5) with at least one bearing arrangement (3, 4, 6, 7) each. The bearing arrangement of at least one end area is designed as an elastomer bearing. The wheel guide control arm (1) has a wheel-side bearing arrangement (6, 7) with an elastomer bearing (7). The wheel guide control arm is especially suitable for the active chassis and for managing the conflict of goals between comfort mounting and precision of wheel guiding. The wheel guide control arm makes it, furthermore, possible to introduce actuator forces or torques into the wheel suspension without induction of appreciable elastic deformations.

### CROSS REFERENCE TO RELATED APPLICATIONS

This application is a United States National Phase application of International Application PCT/DE 2007/000371 and claims the benefit of priority under 35 U.S.C. §119 of German Patent Application DE10 2006 015 169.0 filed Mar. 30, 2006, the entire contents of which are incorporated herein by reference.

### FIELD OF THE INVENTION

The present invention pertains to a wheel guide control arm for an axle of a motor vehicle according to the preamble

### BACKGROUND OF THE INVENTION

Wheel guide control arms, for example, suspension arms, longitudinal control arms or tension rods, are used in practically all wheel suspensions and axles of motor vehicles and are used to movably connect or limit the degrees of freedom of motion of the wheel in relation to the chassis of the vehicle. Usual wheel guide control arms are articulated, in general, non-elastically but in an articulated manner in the area of the wheel, for example, at the wheel carrier, whereas prior-art wheel guide control arms are articulated on the chassis side usually in the form of elastomer joints or rubber bearings.

The chassis-side articulation by means of elastomer bearings is used to absorb tolerance and deformations developing in the axle system because of the static and dynamic wheel loads, on the one hand, and, on the other hand, in the sense of a comfort mounting, for the purpose of damping and uncoupling microvibrations or to reduce the transmission of structure-borne noise from the wheel-carrier to the chassis of the vehicle.

Thus, it is desirable for an effective comfort mounting with effective acoustic uncoupling to use the softest elastomer bearings possible in the area of the chassis-side articulation of the wheel guide control arm. However, a conflict of goals arises compared to the exact wheel guiding, which is desirable in the sense of vehicle dynamics, and the maintenance of the axle kinematics provided by the design, such as track, king pin angle, inclination of the steering knuckle pivot, slowdown and the like, possibly under all occurring driving conditions.

In other words, it is desirable in the sense of axle kinematics and vehicle dynamics to provide the hardest possible or non-elastic connection of the wheel guide control arm not only on the wheel side but also on the chassis side, whereas the goal of a comfort mounting imposes precisely diametrically opposed requirements, calling for the softest possible, elastic connection of the wheel guide control arm to the chassis of the vehicle. These two conflicting requirements can be met so far only in the form of a design compromise somewhere in the middle.

In addition, elastomer bearings arranged at a wheel guide control arm on the chassis side are subject not only to the total forces of the wheel, but these bearings may additionally also be subject to considerable loads resulting from torques because of the lever arm, which the wheel guide control arm forms. This additional load from torques also leads to additional, undesired deformations of the chassis-side elastomer bearings and hence it tends to lead to load-dependent errors in the axle geometry and to an imprecise tracking of the motor vehicle.

The elastomer bearings of the wheel guide control arms known from the state of the art lead, furthermore, to considerable conflicts of design goals in case of applications of the so-called active chassis as well. Considerable forces or torques generated by an actuator are introduced into the wheel suspension of individual wheels and axles in case of an active chassis, for example, but by no means exclusively in case of the active roll stabilization, in order to thus counteract a certain inward deflection or outward deflection motion of the wheel. However, considerable deformations of elastomer bearings of wheel guide control arms, which bearings may be arranged on the chassis side, may now occur due to the forces, and these deformations lead to the described, undesired changes in the axle geometry, on the one hand, but they also make it, on the other hand, difficult or impossible to actively affect, as would be desired, the inward deflection motions of the wheel.

### SUMMARY OF THE INVENTION

Against this background, the object of the present invention is to provide a wheel guide control arm for use, among other things, in an active chassis, with which the drawbacks that can be encountered in the state of the art can be overcome. The wheel guide control arm shall contribute, in particular, to resolving the conflict of goals between comfort mounting, on the one hand, as well as precision of the wheel guiding, on the other hand. In case of use in an active chassis, the wheel guide control arm shall, moreover, permit the reliable introduction of actuator forces into the wheel suspension, without appreciable or undesirably great elastic deformations being induced between the individual components of the wheel suspension.

In a manner basically known in itself, the wheel guide control arm according to the present invention has two end areas, each of the end areas carrying at least one bearing arrangement. The bearing arrangement of at least one end area of the wheel guide control arm comprises, in a manner known in itself, an elastomer bearing.

However, the wheel guide control arm is characterized according to the present invention in that the wheel-side bearing arrangement comprises an elastomer bearing.

The wheel guide control arm according to the present invention is thus advantageous because, as a consequence of the elastomer bearing arranged according to the present invention on the wheel side or the wheel carrier side, the uncoupling concerning acoustics and structure-borne noise, which is desirable in the sense of comfort mounting, continues to be able to be ensured even in case of an especially hard or non-elastic chassis-side articulation. At the same time, the elastomer bearing arranged on the wheel side brings with it the advantage that as a consequence of it being arranged directly at the force introduction point in the area of the wheel carrier, optimal introduction of forces is possible in the area of the wheel carrier without the secondary torques and corresponding deformations present in the state of the art because of the lever arm of the wheel guide control arm.

Finally, the wheel guide control arm according to the present invention is also predestined for use in an active chassis because, due to the possibility of providing a comparatively hard articulated connection of the wheel guide control arm on the chassis side without loss of comfort, a low-loss introduction of actuator forces or controlling torques is possible in an ideal manner, and it is thus possible to affect the inward deflection motions of the wheel in the desired, exactly controllable manner.

Especially against this background, provisions are made according to an especially preferred embodiment of the present invention for the mounting at the chassis-side end area of the wheel guide control arm to be designed as a non-elastic mounting.

An especially exact wheel guiding with the lowest possible deformations in the wheel suspension can be achieved in this manner, because the considerable deformations, which may occur in the state of the art, are eliminated altogether because of secondary torques in the chassis-side mounting, which is inevitably soft there. Furthermore, actuator forces or controlling torques can even be introduced practically without losses in this manner when the wheel guide control arm is used at an active chassis.

According to another preferred embodiment of the present invention, the wheel-side bearing arrangement comprises a ball and socket joint. The ball and socket joint is connected to the wheel-side end of the wheel guide control arm by means of an elastomer bearing. A ball and socket joint is advantageous at this site because ball and socket joints have proved to be very successful in wheel suspensions of motor vehicles. Furthermore, it is possible in this manner to separate the functions between the absorption of steering motions and inward deflection motions of the wheel by the ball and socket joint, on the one hand, while micromotions and undesired vibrations can be absorbed by the elastomer bearing, on the other hand.

The elastomer bearing and the ball and socket joint are preferably arranged now such that the elastomer of the elastomer bearing surrounds the ball and socket joint at least in some areas. Such an essentially concentric arrangement of the elastomer bearing and ball and socket joint has proved to be especially compact and robust, which presents a decisive advantage in the area of the wheel carriers of motor vehicles. In addition, the elastomer bearing may possibly also be designed according to this embodiment of the present invention such that the ball and socket joint is additionally protected by the elastomer from harmful effects or even from external media.

Against this background, provisions are made according to other embodiments of the present invention for the elastomer bearing surrounding the ball and socket joint to be in the form of an elastomer layer, which is arranged essentially radially between the bearing shell and the joint housing of the ball and socket joint, or for the ball and socket joint to comprise an inner joint housing and an outer joint housing, wherein the elastomer layer is arranged radially between the inner and outer joint housings of the ball and socket joint. These embodiments have especially the advantage of being especially compact and robust and, moreover, of combining a modular design with a high level of mounting-friendliness. The latter embodiment is especially useful in ball and socket joints with plastic bearing shells, in which a metal housing directly surrounding the bearing shell is necessary for the shaping support of the plastic bearing shell.

Another embodiment of the present invention provides for the elastomer layer surrounding the ball and socket joint to have different cross-sectional areas in two directions, which are at right angles to one another and radial in relation to the joint housing. This is advantageous because the elastomer bearing surrounding the ball and socket joint can be provided in this manner with different spring rates for different radial directions. The flexibilities of the elastomer bearing can thus be controlled better by the design as a function of the direction in which the forces act.

Provisions are made according to another embodiment of the present invention for an axial stop to be arranged at the inner joint housing in a joint housing made with two shells with an elastomer layer positioned therebetween, the axial stop being surrounded by the outer joint housing. The axial stop is preferably coated with elastomer at least in some areas. It is thus additionally possible to separately control the spring excursion and possibly also the specific spring rate between the outer and inner joint housings in the third direction in space, which is axial in relation to the joint housing. The axial stop is preferably of a ring-shaped design, and is preferably pressed to the inner joint housing in the area of the inner joint housing cover.

According to another, especially preferred embodiment of the present invention, the ball and socket joint is arranged in a recess in the wheel-side end area of the wheel guide control arm. A space-saving and compact arrangement comprising the wheel guide control arm and the ball and socket joint as well as a uniform flux of forces from the wheel guide control arm to the ball and socket joint are thus obtained. The joint housing or, in the case of a joint housing made with two shells, the outer joint housing of the ball and socket joint is preferably formed by the recess in the wheel-side end area of the wheel guide control arm. The combination of functions, which is achieved in this manner, is especially advantageous in respect to the reduction of weight and of the space needed for the installation of the arrangement comprising the wheel guide control arm and the ball and socket joint.

Against the background of the introduction and transmission of actuating forces or controlling torques—in the sense of the active chassis—by the wheel guide control arm into the wheel suspension, provisions are made in another preferred embodiment of the present invention for the chassis-side bearing arrangement to comprise two ball and socket joints arranged at spaced locations from one another. Forces and torques can thus be introduced into the wheel guide control arm in a simple and effective manner, for example, to affect the inward deflection motions of the wheel, and the distance between the two ball and socket joints arranged at the chassis-side end of the wheel guide control arm is used as a lever arm for introducing the necessary forces and torques into the wheel guide control arm.

The present invention will be explained in more detail below on the basis of drawings, which show exemplary embodiments only. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an isometric view of an embodiment for a wheel guide control arm according to the present invention;

FIG. 2 is an enlarged broken away isometric view corresponding to FIG. 1 and showing the wheel-side ball and socket joint of the wheel guide control arm according to FIG. 1;

FIG. 3 is an enlarged bottom isometric view of the ball and socket joint according to FIG. 2;

FIG. 4 is a schematic sectional view of the ball and socket joint of the wheel guide control arm according to FIGS. 1 through 3 in a longitudinal section through the wheel guide control arm and the ball and socket joint;

FIG. 5 is an isometric view of the assembly of the joint housing of a ball and socket joint for a wheel guide control arm according to FIGS. 1 through 4;

FIG. 6 is a top view of the joint housing according to FIG. 5;

FIG. 7 is a sectional view of the joint housing according to FIGS. 5 and 6 in a longitudinal section A-A according to FIG. 6; and

FIG. 8 is a sectional view of the joint housing according to FIGS. 5 through 7 in a longitudinal section B-B according to FIG. 6.

### DESCRIPTION OF THE PREFERRED EMBODIMENTS

Referring to the drawings in particular, FIG. 1 shows an isometric view of an embodiment of a wheel guide control arm according to the present invention.

The fork-shaped design of the wheel guide control arm 1 is recognized, wherein the chassis-side end 2 of the wheel guide control arm 1 is equipped with two ball and socket joints 3, 4 on the left-hand side relative to the drawing, whereas the wheel-side end 5 of the wheel guide control arm 1 shown carries another, single ball and socket joint 6 on the right side relative to the drawing.

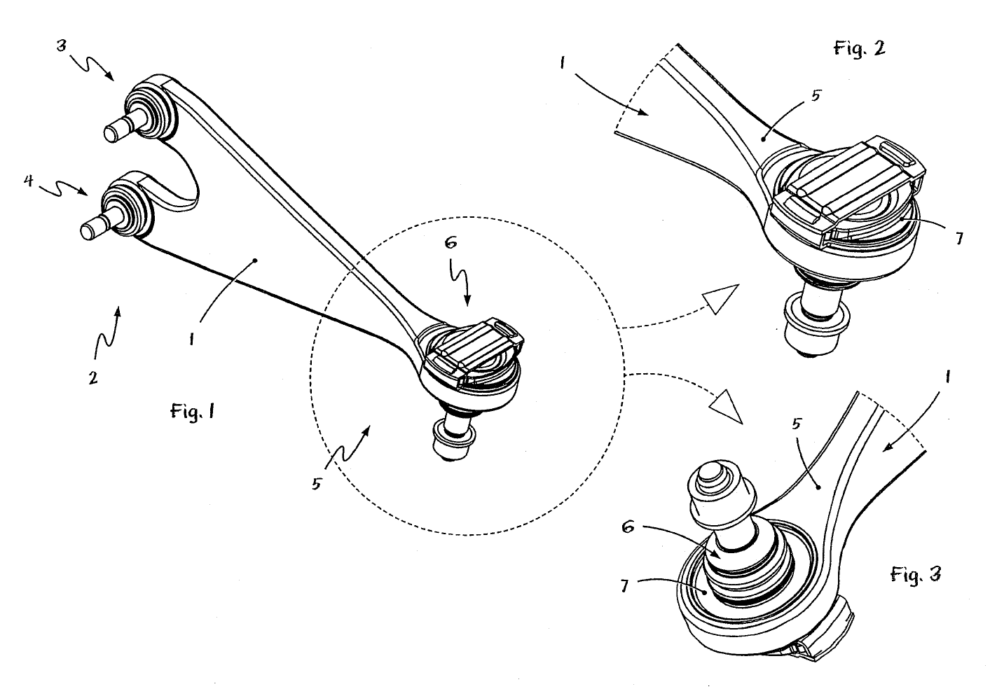

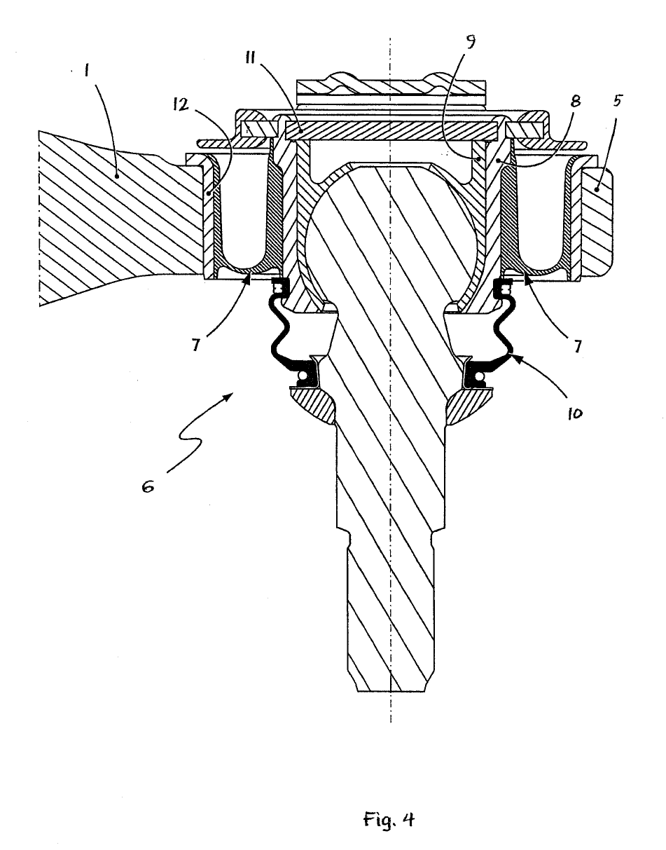

The chassis-side ball and socket joints 3, 4 are received non-elastically in the two fork ends 2 of the wheel guide control arm 1, whereas the wheel-side ball and socket joint 6 is connected to the corresponding end 5 of the wheel guide control arm 1 by means of an inserted elastomer bearing. The arrangement of the elastomer layer 7 surrounding the wheel-side ball and socket joint 6 is already indicated in the enlarged detail views according to FIGS. 2 and 3 and will be described in more detail below with respect to FIGS. 4 through 8.

The wheel guide control arm 1 shown is a control arm that is intended for use in the frame of the active chassis, for example, for the active roll stabilization of a motor vehicle. For the purpose of introducing the corresponding adjusting forces and controlling torques into the wheel guide control arm 1 and hence into the wheel suspension of the wheel to be affected, the wheel guide control arm 1 shown according to FIG. 1 has on the chassis side not only a suspension, but two ball and socket joints 3, 4 arranged at spaced locations from one another. The intended forces and torques can thus be introduced into the wheel suspension with the use of the distance between the two chassis-side ball and socket joints 3, 4 as a lever arm and—thanks to the chassis-side support points 3, 4, which is non-elastic, unlike in the state of the art—they can be transmitted effectively and without loss to the wheel carrier (not shown) at the wheel-side end 5 of the wheel guide control arm 1.

Yet, an effective vibration damping continues to be ensured between the wheel carrier and the chassis of the vehicle thanks to the present invention in the sense of the comfort mounting due to the fact that the wheel-side ball and socket joint 6 is connected to the wheel-side end 5 of the wheel guide control arm 1 according to the present invention with the insertion of an elastomer bearing 7.

It can be clearly recognized especially in the view according to FIG. 3 that the elastomer bearing 7 surrounds the ball and socket joint 6 along the entire circumference thereof, as a result of which a complete, effective uncoupling is given between the ball and socket joint 6 and the wheel-side end 5 of the wheel guide control arm 1 in respect to microvibrations and the transmission of structure-borne noise.

FIG. 4 shows a longitudinal section through the wheel guide control arm 1 in the area of its wheel-side end as well as through the ball and socket joint 6 present there. What appears especially clearly from FIG. 4 as well is the complete uncoupling between the wheel guide control arm 1 and the ball and socket joint 6 by means of the elastomer bearing 7.

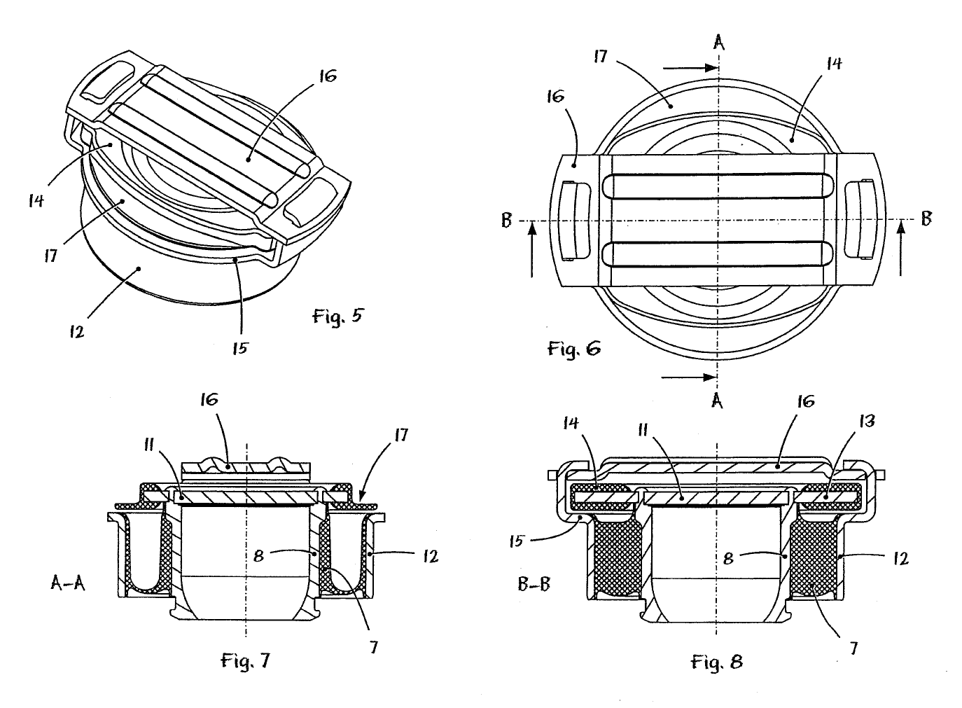

As can be seen, the elastomer bearing 7 has an especially small cross section along the direction of the section, which coincides with the longitudinal axis of the wheel guide control arm in FIG. 4 and is consequently also the same as the section A-A according to FIGS. 6 and 7. The elastomer bearing 7 therefore also has an especially soft spring rate in the direction of the section according to FIGS. 4 and 7.

Furthermore, it appears from FIG. 4 that the ball and socket joint 6 being shown has a two-shell joint housing. The inner shell 8 of the joint housing accommodates the bearing shell 9 of the ball and socket joint 6, which bearing shell consists of a plastic, and is used, furthermore, to fasten the sealing bellows 10 and the housing cover 11. The outer shell of the joint housing 12 is used to accommodate the ball and socket joint 6 in a corresponding cylindrical recess in the wheel-side end of the wheel guide control arm 1. Finally, the elastomer bearing 7 is arranged, preferably attached by vulcanization, between the two shells 8, 12 of the joint housing.

FIGS. 5 through 8 show once again assembly views for the joint housing of the ball and socket joint 6 connected elastically to the wheel-side end 5 of the wheel guide control arm 1. The sectional view according to FIGS. 7 and 8 show especially clearly the cross section of the elastomer layer 7 arranged between the outer joint housing shell 12 and the inner joint housing shell 8, which differs as a function of the direction of the section and is responsible for the correspondingly different spring rates in the two directions A-A and B-B according to the sections in FIG. 6, which directions are at right angles to one another.

A comparison especially of FIGS. 7 and 8 shows, furthermore, the design of an axial stop 13 of the ball and socket joint, which stop is additionally present in this embodiment. The axial stop 13 is formed by an essentially ring-shaped plate 13, which is pressed to the inner joint housing 8 of the ball and socket joint in the area of the inner housing cover 11. The ring-shaped plate 13 is extrusion coated with an elastomer 14 and thus acts as a stop during relative motions between the inner joint housing 8 and the outer joint housing 12 in the axial direction of the joint housing. The axial stop 13 formed by the elastomer-coated ring-shaped plate strikes a ring-shaped, circumferential shoulder 15 of the outer joint housing 12 during relative motions of the inner joint housing 8 in the downward direction relative to the drawing, whereas the axial stop 13 strikes the plate-shaped cover 16 of the outer joint housing 12 during relative upward motions of the inner joint housing 8 relative to the drawing.

Another advantageous function of the axial stop 13 is a certain additional protection of the ball and socket joint from environmental effects by means of a sealing lip 17, whose shape appears especially from the sectional view according to FIG. 7.

Thus, it becomes clear as a result that the present invention leads to a wheel guide control arm for use, for example, in an active chassis, which wheel guide control arm has decisive advantages over the state of the art concerning the management of the conflict of goals between comfort mounting and precision of the wheel guiding. In particular, the wheel guide control arm according to the present invention makes possible the effective introduction of actuator forces or torques into the wheel guide control arm or into the wheel suspension without induction of appreciable elastic deformations in the wheel suspension.

Thus, the present invention makes an important contribution in respect to the improvement of both the comfort properties of the chassis and the improved management of stability of wheel suspensions, especially for the case of use in demanding axle systems and in the new area of the active chassis.

While specific embodiments of the invention have been shown and described in detail to illustrate the application of the principles of the invention, it will be understood that the invention may be embodied otherwise without departing from such principles.

1-13. (canceled)

14. A wheel guide control arm for an axle of a motor vehicle, said wheel guide control arm comprising: two end areas, each of said end areas having at least one bearing arrangement, wherein:
at least one of said bearing arrangements comprises a wheel-side bearing arrangement; and
said wheel-side bearing arrangement comprises an elastomer bearing.

15. A wheel guide control arm in accordance with claim 14, wherein one of said two end areas of said wheel guide control arm is a chassis-side end area and said bearing arrangement at said chassis-side end area is a non-elastic bearing.

16. A wheel guide control arm in accordance with claim 14, wherein said wheel-side bearing arrangement comprises a ball and socket joint connected to said wheel-side end of said wheel guide control arm by said elastomer bearing.

17. A wheel guide control arm in accordance with claim 16, wherein said elastomer bearing surrounds said ball and socket joint at least in some areas as an elastomer layer.

18. A wheel guide control arm in accordance with claim 16, wherein said elastomer bearing comprises an elastomer layer arranged essentially radially between a bearing shell and the joint housing of said ball and socket joint.

19. A wheel guide control arm in accordance with claim 16, wherein said ball and socket joint comprises an inner joint housing and an outer joint housing, wherein said elastomer bearing comprises an elastomer layer arranged essentially radially between said inner joint housing and said outer joint housing of said ball and socket joint.

20. A wheel guide control arm in accordance with claim 18, wherein said elastomer layer has different cross-sectional areas in two directions, which are at right angles to one another and radial in relation to said joint housing.

21. A wheel guide control arm in accordance with claim 19, wherein an axial stop is surrounded by the outer joint housing and is arranged at the inner joint housing.

22. A wheel guide control arm in accordance with claim 21, wherein the axial stop is coated with elastomer at least in some areas.

23. A wheel guide control arm in accordance with claim 21, wherein said axial stop has a ring-shaped design and is pressed to said inner joint housing in an area of an inner joint housing cover.

24. A wheel guide control arm in accordance with claim 16, wherein a ball and socket joint is arranged in a recess in said wheel-side end area of the wheel guide control arm.

25. A wheel guide control arm in accordance with claim 19, wherein said joint housing or an outer joint housing of said ball and socket joint is formed by recess in said wheel-side end area of the wheel guide control arm.

26. A wheel guide control arm in accordance with claim 15, wherein said chassis-side bearing arrangement comprises two ball and socket joints.

27. A wheel guide control arm for an axle of a motor vehicle, said wheel guide control arm comprising:
a chassis-side end area having a chassis side bearing arrangement with a non-elastic bearing;
a wheel-side end area having a wheel-side bearing arrangement, said wheel-side bearing arrangement comprising an elastomer bearing.

28. A wheel guide control arm in accordance with claim 27, wherein said wheel-side bearing arrangement further comprises a ball and socket joint connected to said wheel-side end of said wheel guide control arm by said elastomer bearing with said elastomer bearing surrounding said ball and socket joint at least in some areas as an elastomer layer.

29. A wheel guide control arm in accordance with claim 28, wherein said elastomer bearing comprises said elastomer layer arranged essentially radially between a bearing shell and the joint housing of said ball and socket joint.

30. A wheel guide control arm in accordance with claim 28, wherein said ball and socket joint comprises an inner joint housing and an outer joint housing, wherein said elastomer bearing comprises an elastomer layer arranged essentially radially between said inner joint housing and said outer joint housing of said ball and socket joint.

31. A wheel guide control arm in accordance with claim 28, wherein said elastomer layer has different cross-sectional areas in two directions, which are at right angles to one another and radial in relation to said joint housing.

32. A wheel guide control arm in accordance with claim 30, wherein an axial stop is surrounded by the outer joint housing and is arranged at the inner joint housing, wherein said axial stop is coated with elastomer at least in some areas and has a ring-shaped design and is pressed to said inner joint housing in an area of an inner joint housing cover.

33. A wheel guide control arm in accordance with claim 28, wherein said joint housing or an outer joint housing of said ball and socket joint is formed by recess in said wheel-side end area of the wheel guide control arm and said chassis-side bearing arrangement comprises two ball and socket joints.
